(19) United States
(12) Patent Application Publication
(10) Pub. No.: US 2026/0032412 A1
(43) Pub. Date: Jan. 29, 2026

(54) METHODS AND SIGNALING FOR UE-ASSISTED AMBIENT INTERNET OF THINGS

(71) Applicant: APPLE INC., Cupertino, CA (US)

(72) Inventors: Ankit Bhamri, Bad Nauheim (DE); Huaning Niu, San Jose, CA (US); Hong He, San Jose, CA (US); Haitong Sun, Cupertino, CA (US); Wei Zeng, San Diego, CA (US); Dawei Zhang, Saratoga, CA (US); Oghenekome Oteri, San Diego, CA (US); Sigen Ye, San Diego, CA (US)

(21) Appl. No.: 19/048,363

(22) Filed: Feb. 7, 2025

Related U.S. Application Data
(60) Provisional application No. 63/553,796, filed on Feb. 15, 2024.

(51) Int. Cl. H04W 4/70; H04L 5/00

(52) U.S. Cl. CPC H04W 4/70; H04L 5/0053

(57) ABSTRACT

Embodiments herein propose methods, systems, and apparatuses for configuring a user equipment (UE) to operate in a UE-assistance mode for ambient Internet of Things (IoT). The UE may receive a configuration from a base station that specifies parameters associated with the UE-assistance mode. The UE may determine the parameters to execute one or more functions inherent to the UE-assistance mode. By performing these functions, the UE may assist in communication between the base station and an ambient IoT device.

### TECHNICAL FIELD

This application relates generally to wireless communication systems, including configuration of a user equipment for ambient IoT communications.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example of a first mode (Mode 1) of UE assistance in accordance with one or more embodiments of the present disclosure.

FIG. 2 shows an example of a second mode of UE assistance in accordance with some embodiments.

FIG. 3 shows an example of a third mode of UE assistance in accordance with one or more embodiments of the present disclosure.

FIG. 4 illustrates an example RRC IE for configuring UE assistance with an ambient IoT device in accordance with some embodiments.

FIG. 5 illustrates a method for a UE, according to embodiments herein.

FIG. 6 illustrates a method for a base station, according to embodiments herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Additionally, embodiments herein are described with regard to Internet of Things (IoT) devices. Reference to an IoT device is merely provided for illustrative purposes, and the embodiment herein may be utilized with any device that have the capability to collect and exchange data. IoT devices may be embedded with sensors, software, and network connectivity, allowing them to communicate with other devices and systems. IoT devices can vary in size, complexity, and functionality. They can range from small, simple devices such as temperature sensors and smart home appliances to more complex devices like industrial machinery and autonomous vehicles.

Some IoT devices include ambient IoT devices. An ambient IoT device is a device that is able to harvest energy from ambient sources. For example, some ambient IoT devices may use radio frequency (RF) waves for power. To power such devices using RF, embodiments herein provide enhancements to a wireless communication system framework to introduce a new category of device(s) that is able to harvest energy from ambient sources. An ambient IoT device may be referred to as an RF powered device. An ambient IoT device may also be a UE device.

There may be multiple types of ambient IoT devices that the wireless communication system may support. For instance, in terms of energy storage, some devices may be battery-less devices with no energy storage capability at all, and completely dependent on the availability of an external source of energy. Some devices may include limited energy storage capability that do not need to be replaced or recharged manually, but can be charged by harvesting energy from ambient sources. In some embodiments, device categorization may be based on characteristics corresponding to a device (e.g., energy source, energy storage capability, passive/active transmission, etc.).

Embodiments herein consider the following set of ambient IoT devices. A first device type, (Device 1) may operate with around one microwatt (μW) peak power consumption, have energy storage, have an initial sampling frequency offset (SFO) up to 10× parts per million (ppm) (e.g., 10⁵ ppm), and provide neither reader-to-device (R2D) (e.g., downlink (DL)) nor device-to-reader (D2R) (e.g., uplink (UL)) amplification. The first device type's D2R transmission is backscattered on a carrier wave provided externally. For instance, a device may not generate its own active transmission, and reflect or backscatter an incoming signal (carrier wave).

A second device type (Device 2a) may operate with up with a peak power consumption of up to a few hundred u W, have energy storage, have an initial SFO up to 11× ppm, and provide both R2D and/or D2R amplification in the second device. The second device type's D2R transmission is backscattered on a carrier wave provided externally.

A third device type (Device 2b) may operate with up with a peak power consumption of up to a few hundred u W, have energy storage, have an initial SFO up to 10× ppm, and provide both R2D and/or D2R amplification in the third device. The third device type's D2R transmission may be generated internally by the device.

Note that R2D in ambient IoT may be downlink from the reader to the device and the channel for the R2D may be refed to as physical reader to device channel (PRDCH). D2R in ambient IoT may be uplink from the device to reader and the channel for the D2R may be refed to as physical device to reader channel (PDRCH).

The following disclosure considers at least two deployment scenarios and two topologies. A first case can be a first deployment scenario with Topology 1 (e.g., direct communication between a base station (BS) and a Device). Within the first case, the BS can be indoor which is the reader and the ambient IoT device can also be indoor. Furthermore, the first case can include the only direct connectivity between BS and ambient IoT device. The base station and coexistence characteristics may include micro-cell and co-site.

According to the following disclosure, the second case can include a second deployment scenario with a second Topology. Within the second case, the BS can be outdoor and the ambient IoT device can also be indoor, while an intermediate node can be indoor, where the intermediate node can be the reader. Furthermore, the second case can include connectivity between BS and ambient IoT device via the intermediate node (UE), where the intermediate UE can be configured as a reader. The base station and coexistence characteristics of the second topology may be Macro-cell and co-site. The current standard is for a coverage range of 10-50 meters for the above topologies and deployment scenarios.

In some embodiments, a UE could be utilized for assisting with ambient IoT in multiple scenarios. In a first scenario, a UE can assist by just providing carrier wave to the ambient IoT device. In such a scenario, the UE may not be a reader, but it is used for the purpose of providing the carrier wave. The rest of the communication may be done between the ambient IoT device and a reader (e.g., a base station) while the UE could provide the carrier wave transmission.

In a second scenario, where an assisting UE is uses, the UE can act as a relay and forward R2D/D2R (e.g., DL/UL) channels/signals and/or carrier wave between the base station and the ambient IoT device. The reader may act as the reader for the ambient IoT device and forward data to the base station.

This disclosure proposes details related to the new signaling framework required for the base station to communicate control signaling to the assisting UE for supporting ambient IoT device either for just transmission of carrier wave to the ambient IoT devices or for only communication as a reader with the ambient IoT devices or both for carrier wave transmission and communication as a reader with the ambient IoT devices. In particular, developments for either a new DCI format or enhancement to legacy DCI formats and control information related details for different UE configurations are discussed.

In some embodiments, a UE may be configured with one of the following modes (Mode 1, Mode 2, or Mode 3) by the network to provide assistance for ambient IoT. The network may in this way configure operation of the UE to assist in ambient IoT communication. In Mode 1 the UE may only generate carrier-wave for transmitting to ambient IoT devices.

In Mode 2 a UE may receive carrier-wave and R2D (e.g., DL) channels/signals from base station (e.g., gNB) and forward the R2D signals to the ambient IoT device and/or receive the backscatter signal from ambient IoT device. In some embodiments, a UE operating in a subset of Mode 2 (i.e., Mode 2-1), the UE may process/decode the backscatter signal from ambient IoT device and forward the processed/decoded information to the base station. In some embodiments, a UE operating in a subset of Mode 2 (i.e., Mode 2-2), the UE may only forward the backscatter signal without decoding the backscatter signal from ambient IoT device toward the base station.

In mode 3, a UE may receive R2D (e.g., DL) channel/signal from a base station and forward the R2D signal to the ambient IoT device and additionally the UE generates carrier-wave and transmits it to ambient IoT device. In some embodiments, a UE operating in a subset of Mode 3 (i.e., Mode 3-1), the UE may process/decode the backscatter signal from ambient IoT device and forward the processed/decoded information to the base station. In some embodiments, a UE operating in a subset of Mode 3 (i.e., Mode 3-2), the UE may only forward the backscatter signal without decoding the backscatter signal from ambient IoT device towards the base station.

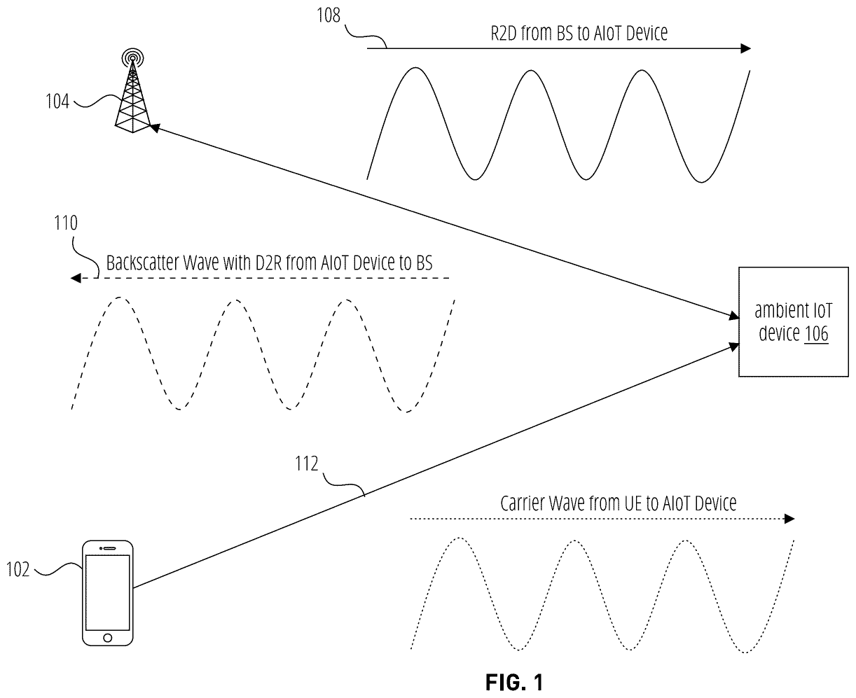

FIG. 1 shows an example of a first mode (Mode 1) of UE assistance in accordance with one or more embodiments of the present disclosure. The base station 104 may configure the UE 102 to operate in Mode 1 to provide assistance for ambient IoT. In Mode 1, the UE 102 only generates a carrier wave 112 for transmitting to ambient IoT devices (e.g., ambient IoT device 106).

As shown, the base station 104 may be a reader and may communicate with the ambient IoT device 106. The base station 104 may send an R2D signal 108 to the ambient IoT device 106. The UE 102 may be configured to transmit the carrier wave 112. The carrier wave 112 may be used by the ambient IoT device 106 to send data via the backscatter wave 110. Accordingly, in the illustrated embodiment, the UE 102 operating in Mode 1 may be unaware about communication that is happening between the base station 104 and the ambient IoT device 106.

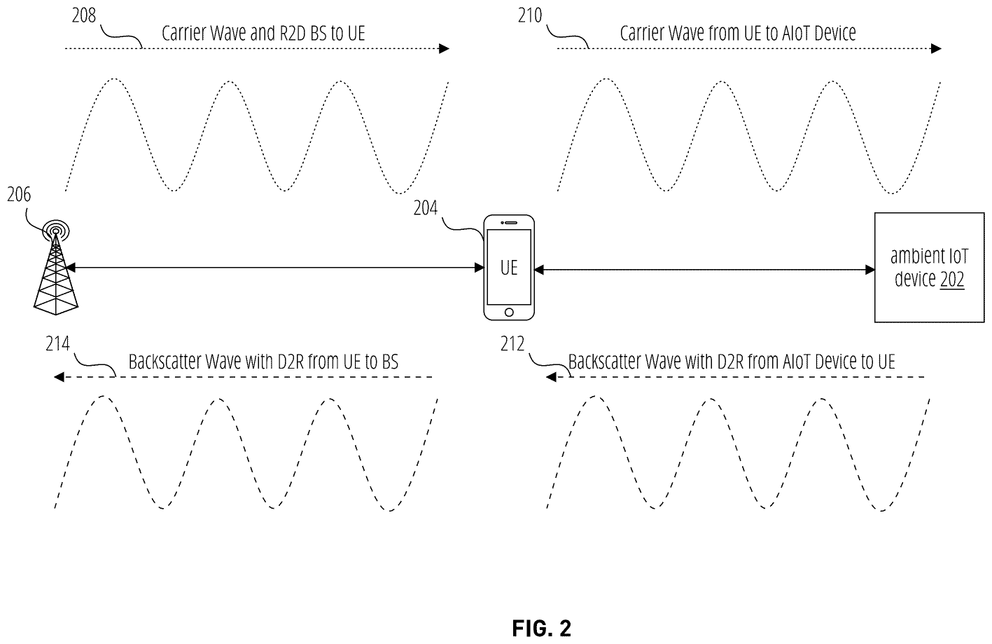

FIG. 2 shows an example of a second mode of UE assistance in accordance with some embodiments. In at least one embodiment, a second mode can include a UE 204 that is configured to receive a carrier-wave and R2D channels/signals (e.g., carrier wave and R2D 208) from the base station 206 and forward the R2D channels/signals (e.g., carrier wave 210) to the ambient IoT device 202, and/or receives the backscatter signal 212 from the ambient IoT device 202.

In at least one embodiment, the UE 204 processes/decodes the backscatter signal 212 from the ambient IoT device 202 and forwards the signal (e.g., forwarded signal 214) to the base station 206. In at least one embodiment, the UE 204 can forward the signal (e.g., forwarded signal 214) without decoding the backscatter signal from ambient IoT device towards base station 206. Accordingly, in mode 2, the UE 204 may act as both the carrier wave transmitter and an intermediate reader node.

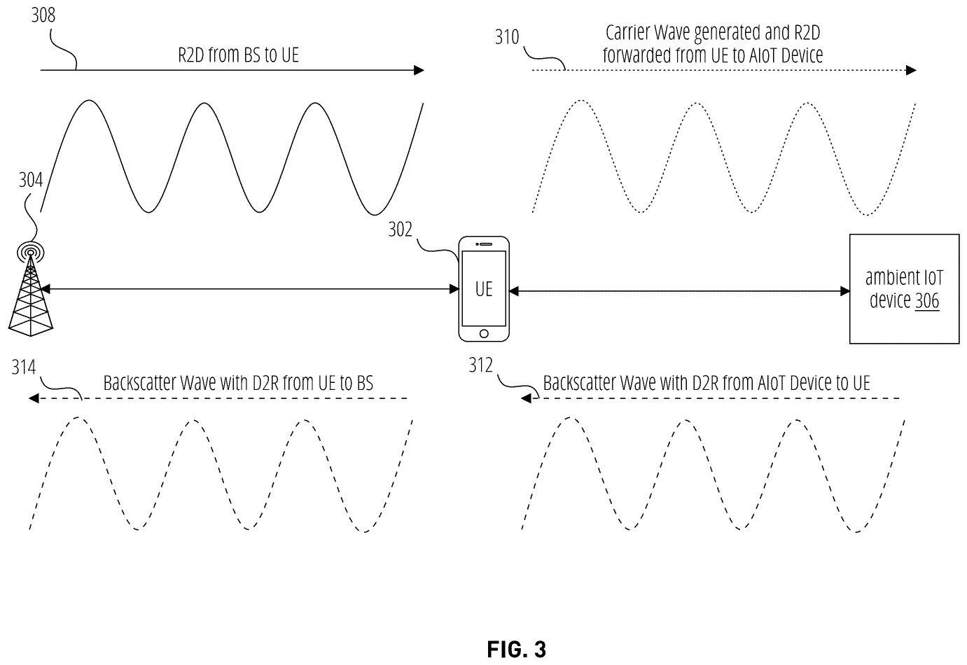

FIG. 3 shows an example of a third mode of UE assistance in accordance with one or more embodiments of the present disclosure. In at least one embodiment, while in a third mode the UE 302 can receive a R2D channel/signal (e.g., R2D signal 308) from base station 304 and can forward it to an ambient IoT device 306. Additionally, the UE 302 can generate a carrier-wave and transmit it to an ambient IoT device 306. For example, in the illustrated embodiment, the UE 302 sends the carrier wave and R2D signal 310 to the ambient IoT device 306.

The UE may receive a backscatter signal 312 with D2R data from the ambient IoT device 306. In some embodiments, the UE 302 may process/decode the backscatter signal 312 from ambient IoT device 306 and forward it to the base station 304 (e.g., forwarded signal 314). In some embodiments, the UE 302 can forward the signal (e.g., forwarded signal 314) without decoding the backscatter signal 312 from ambient IoT device 306 towards the base station 304.

In some embodiments, the UE may report its capability to the network. For example, the UE may report that it is capable of generating a carrier wave, conducting reader functionalities, or both generating a carrier wave and conducting reader functionalities. The network may configure the UE to operate in a specific UE assistance mode (e.g., Mode 1, Mode 2, or Mode 3 shown in FIG. 1, FIG. 2, or FIG. 3).

Signaling between the base station and the intermediate UE may be done via radio resource control (RRC) messaging. In at least one embodiment, a new RRC information element (IE) can be introduced for the purpose of configuring UE-assistance modes for ambient IoT and corresponding time-domain behavior configuration for each of the configured modes. The IE may be able to configure one or combination of multiple modes, and time-domain behavior for each mode.

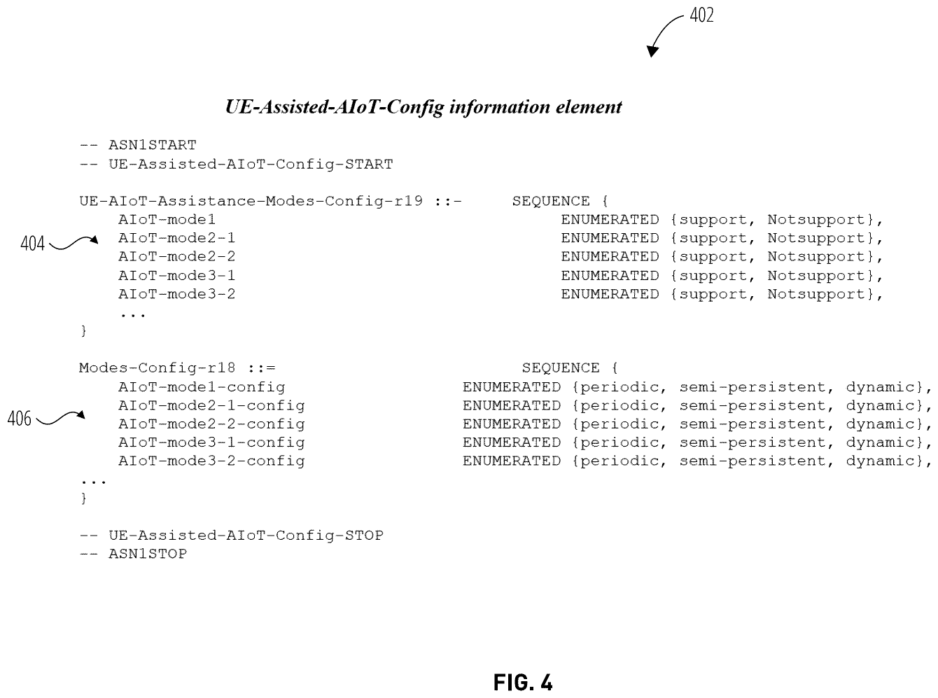

FIG. 4 illustrates an example RRC IE for configuring UE assistance with an ambient IoT device in accordance with some embodiments. As shown, the IE may be referred to as a UE-Assisted-AIoT-Config IE 402. The UE-Assisted-AIoT-Config IE 402 may be able to configure one or more UE-assistance modes for ambient IoT and corresponding time-domain behavior configuration for each of the configured mode.

For instance, the UE-Assisted-AIoT-Config IE 402 may include a supported mode field 404 that indicates which modes are supported and which modes are not supported. The UE-Assisted-AIoT-Config IE 402 may also include a time-domain behavior field 406 that may indicate the time-domain behavior for each mode. In the illustrated embodiment, the time-domain behavior field 406 may indicate a mode as cither periodic, semipersistent, or dynamic.

In some embodiments, a default mode can be configured and other modes could be optional. In some embodiments, for all the configured modes, either a same time-domain behavior or separate time-domain behavior for each mode can be configured. In some embodiments, the structure of the IE may vary depending on the adopted methods discussed previously.

In some embodiments of the present disclosure, the base station may provide configuration details for the UE-assistance modes. In at least one embodiment, the following parameters/information may be signaled by the base station via RRC IE for the periodic configuration of mode 1 for UE-assistance for ambient IoT. The periodic configuration details for mode 1 can include one or more of carrier wave/backscatter wave parameters, frequency band size, transmit (Tx) power, duration of carrier wave within a period, periodicity, starting time within a period, and/or size of the gap between carrier wave/backscatter wave (if configured). In some embodiments, a list of periodic configurations for UE-assistance for multiple ambient IoT devices and/or device categories could be configured, where each configuration includes the above configured parameters. For example, there may be multiple sets of configurations configured with separate values for each of these parameters.

In some embodiments, a base station may signal, via RRC IE, various parameters/information for the periodic configuration of mode 2-1 for UE-assistance for ambient IoT. The parameters/information for the periodic configuration of mode 2-1 may include carrier wave parameters, R2D wave parameters, and backscatter wave parameters.

The periodic configuration details for mode 2-1 can include carrier (unmodulated) wave parameters. In some embodiments, these carrier wave parameters can include one or more of frequency band/spectrum, power amplification factor for forwarding to ambient IoT devices, duration within a period in terms of number of symbols or slots or frame to absolute duration, periodicity in terms of number of symbols or slots or frame to absolute duration, and/or the starting time within a period in terms slot and/or symbol and/or frame and/or absolute duration offset.

Further, the parameters for mode 2-1 for UE-assistance for ambient IoT can include R2D (e.g., DL) (modulated) wave parameters. In at least one embodiment, the R2D wave parameters can include one or more of frequency band/spectrum, power amplification factor for forwarding to ambient IoT devices, duration within a period in terms of number of symbols or slots or frame to absolute duration, periodicity in terms of number of symbols or slots or frame to absolute duration, and/or the starting time within a period in terms slot and/or symbol and/or frame and/or absolute duration offset.

In some embodiments, the parameters for mode 2-1 for UE-assistance for ambient IoT can include backscatter wave parameters. In one embodiment, the backscatter wave parameters can include the same parameters as the carrier wave, except for an additional timing gap between the carrier wave reception/forwarding and backscattering forwarding and Tx power for forwarding of the backscattering wave to the base station.

In some embodiments, the backscatter wave parameters of mode 2-1 can include a dedicated set of parameters for backscatter wave forwarding, frequency band/spectrum, Tx power for forwarding of backscattering wave to the base station, and the duration within a period in terms of number of symbols or slots or frame to absolute duration, periodicity in terms of the number of symbols or slots or frame to absolute duration, and/or the starting time within a period in terms slot and/or symbol and/or frame and/or absolute duration offset. In some embodiments, a list of periodic configurations for UE-assistance for multiple ambient IoT devices and/or device categories could be configured, where each configuration includes the above configured parameters.

In some embodiments, a base station may signal, via RRC IE, various parameters/information for the periodic configuration of mode 2-2 for UE-assistance for ambient IoT. The periodic configuration details for mode 2-2 can include carrier (unmodulated) wave parameters. In some embodiments, these carrier wave parameters can include one or more of frequency band/spectrum, power amplification factor for forwarding to ambient IoT devices, duration within a period in terms of number of symbols or slots or frame to absolute duration, periodicity in terms of number of symbols or slots or frame to absolute duration, and/or the starting time within a period in terms slot and/or symbol and/or frame and/or absolute duration offset.

Additionally, the parameters for mode 2-2 for UE-assistance for ambient IoT can include R2D (modulated) wave parameters. In at least one embodiment, the R2D wave parameters can include one or more of frequency band/spectrum, power amplification factor for forwarding to ambient IoT devices, duration within a period in terms of number of symbols or slots or frame to absolute duration, periodicity in terms of number of symbols or slots or frame to absolute duration, and/or the starting time within a period in terms slot and/or symbol and/or frame and/or absolute duration offset.

In some embodiments, the parameters for mode 2-2 for UE-assistance for ambient IoT can include backscatter wave parameters. In one embodiment, the backscatter wave parameters can include the same parameters as the carrier wave, except for a different or same power amplification factor for forwarding of backscattering wave to the base station. In some embodiments, a list of periodic configurations for UE-assistance for multiple ambient IoT devices and/or device categories could be configured, where each configuration includes the above configured parameters.

In some embodiments, a base station may signal, via RRC IE, various parameters/information for the periodic configuration of mode 3-1 for UE-assistance for ambient IoT. The periodic configuration details for mode 3-1 can include carrier (unmodulated) wave parameters, R2D wave parameters, and backscatter wave parameters. In some embodiments, these carrier wave parameters can include one or more of frequency band/spectrum, Tx power for transmitting to ambient IoT devices, duration within a period in terms of number of symbols or slots or frame to absolute duration, periodicity in terms of number of symbols or slots or frame to absolute duration, and/or the starting time within a period in terms slot and/or symbol and/or frame and/or absolute duration offset.

Additionally, the parameters for mode 3-1 for UE-assistance for ambient IoT can include R2D (modulated) wave parameters. In at least one embodiment, the R2D wave parameters can include one or more of frequency band/spectrum, power amplification factor for forwarding to ambient IoT devices, duration within a period in terms of number of symbols or slots or frame to absolute duration, periodicity in terms of number of symbols or slots or frame to absolute duration, and/or the starting time within a period in terms slot and/or symbol and/or frame and/or absolute duration offset.

In some embodiments, the parameters for mode 3-1 for UE-assistance for ambient IoT can include backscatter wave parameters. In one embodiment, the backscatter wave parameters can include the same parameters as the carrier wave, except for an additional timing gap between the carrier wave reception/forwarding and backscattering forwarding and Tx power for forwarding of the backscattering wave to the base station.

In some embodiments, the backscatter wave parameters for mode 3-1 can include a dedicated set of parameters for backscatter wave forwarding, frequency band/spectrum, Tx power for forwarding of backscattering wave to the BS, and the duration within a period in terms of number of symbols or slots or frame to absolute duration, periodicity in terms of the number of symbols or slots or frame to absolute duration, and the starting time within a period in terms slot and/or symbol and/or frame and/or absolute duration offset.

In some embodiments, a list of periodic configurations for UE-assistance for multiple ambient IoT devices and/or device categories could be configured, where each configuration includes the above configured parameters.

In some embodiments, a base station may signal, via RRC IE, various parameters/information for the periodic configuration of mode 3-2 for UE-assistance for ambient IoT. The periodic configuration details for mode 3-2 can include carrier (unmodulated) wave parameters, R2D wave parameters, and backscatter wave parameters.

In some embodiments, the carrier wave parameters can include one or more of frequency band/spectrum, Tx power for transmitting to ambient IoT devices, duration within a period in terms of number of symbols or slots or frame to absolute duration, periodicity in terms of number of symbols or slots or frame to absolute duration, and/or the starting time within a period in terms slot and/or symbol and/or frame and/or absolute duration offset.

The parameters for mode 3-2 for UE-assistance for ambient IoT can include R2D (modulated) wave parameters. In at least one embodiment, the R2D wave parameters can include one or more of frequency band/spectrum, power amplification factor for forwarding to ambient IoT devices, duration within a period in terms of number of symbols or slots or frame to absolute duration, periodicity in terms of number of symbols or slots or frame to absolute duration, and/or the starting time within a period in terms slot and/or symbol and/or frame and/or absolute duration offset.

In some embodiments, the parameters for mode 3-2 for UE-assistance for ambient IoT can include backscatter wave parameters. In one embodiment, the backscatter wave parameters can include the same parameters as the carrier wave, except for an additional timing gap between the carrier wave reception/forwarding and backscattering forwarding and Tx power for forwarding of the backscattering wave to the base station.

In another embodiment, the backscatter wave parameters for mode 3-2 can include the same parameters as the carrier wave, except for an amplification factor for forwarding of backscattering wave to the base station.

In at least one embodiment, a list of periodic configurations for UE-assistance for multiple ambient IoT devices and/or device categories can be configured, where each configuration can contain a configured parameter listed above or elsewhere.

In at least one embodiment, the same configuration parameters as described with reference to periodic configurations may be configured separately for semi-persistent configuration for each mode. Further, a new MAC CE can be configured to activate/trigger one or more of the configurations from the list of configurations for the configured mode.

In some embodiments, a new DCI format can be used for the purpose of UE-assisted ambient IoT for dynamic configuration. The DCI may include bitfields such as mode indication. The mode indication bitfield may indicate which UE assistance mode the UE is to operate in. The mode indication bitfields may depend on the number of mode supported by UE, 0 or multiple bits may be used for mode indication. For example, to indicate up to 3 modes, 2 bits can be contained within the mode indication or if the UE indicated support for one mode then 0 bits may be needed for mode indication. In some embodiments, depending on the mode indication, a different set of bitfields can be indicated by the DCI.

Additional fields in the DCI may vary depending on the mode indicated in the mode indication bitfield. In some embodiments for the new proposed DCI, if the mode indication field indicates mode 1, then at least following bitfields can be indicated in the DCI. The bitfields included in a DCI for mode 1 may include the duration of the carrier wave, the starting time of the carrier wave, and/or the gap between the carrier wave/backscatter wave (if configured).

In at least one embodiment for the new proposed DCI, if the mode indication field indicates mode 2-1 or 2-2 or 3-1 or 3-2, then various bitfields can be indicated by the DCI. In some embodiments, bitfields such as transmission type, R2D forwarding, and/or carrier wave forwarding and backscattering forwarding can be indicated in bitfields of the DCI. If R2D forwarding is indicated, then bitfields such as duration of R2D forwarding, and the starting time of R2D forwarding can be included in the DCI. If carrier wave forwarding and backscattering forwarding is indicated, then bitfields such as duration of carrier wave, starting time of carrier wave, and gap between carrier wave/backscatter wave (if configured) can be included in the DCI.

In some embodiments of the present disclosure, a continuous mode for UE-assisting ambient IoT mode can be configured wherein an activation command or trigger is sent to the UE to initiate a continuous carrier wave to the ambient IoT devices. In at least one embodiment, the UE may continue to transmit the carrier wave until a deactivation command is sent. In one embodiment, a MAC CE can be used to indicate to the UE about the activation and deactivation of a continuous carrier wave. In another embodiment, a DCI based dynamic trigger can be included in the new proposed DCI, where a single bit is used to toggle between activation and deactivation of the continuous carrier wave. In another alternative embodiment, beam sweeping for a continuous carrier wave can be configured. In some embodiments, duration and beam direction (TCI state) may be additionally indicated for each beam.

In at least some embodiments, a new UE capability signaling can be used by the UE to indicate support for assisting with ambient IoT. The UE may send the capability signaling to the base station to indicate which modes it can support. Furthermore, if the UE indicates it is capable of supporting ambient IoT assistance, it may additionally report which modes it supports. For example, the UE can report support for one or more of mode 1, mode 2-1, mode 2-2, mode 3-1, and/or mode 3-2.

In some embodiments, the UE may additionally report the support for full-duplex capability, i.e. transmitting carrier wave and receiving the corresponding backscattered wave on the same spectrum and same time (with delta delay). The UE may additionally report the support frequency conversion functionality. For example, the UE can receive a carrier wave on the R2D spectrum from base station and forward it on D2R spectrum or alternatively.

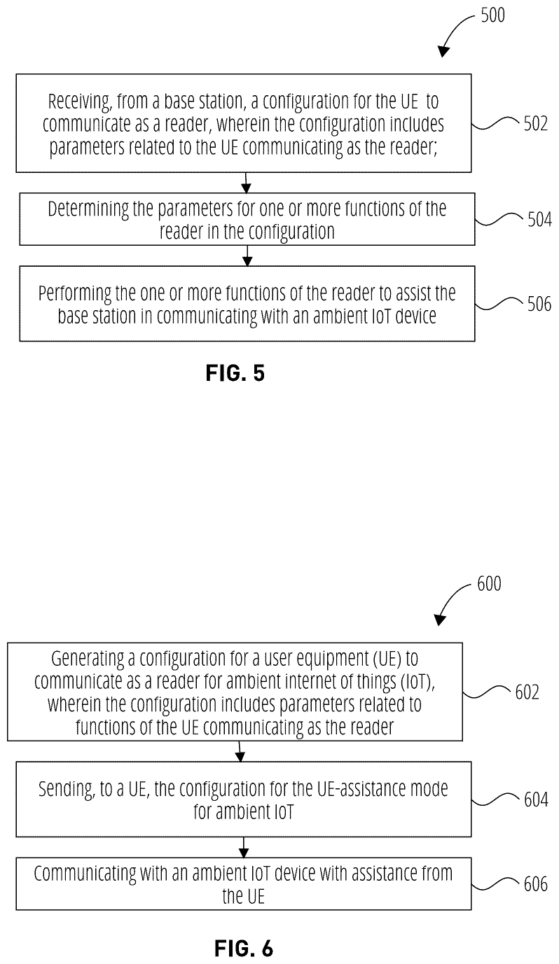

FIG. 5 illustrates a method 500 for a UE, according to embodiments herein. The illustrated method 500 includes receiving 502, from a base station, a configuration for a UE to communicate as a reader for ambient IoT, wherein the configuration includes parameters related to the UE communicating as the reader. The method 500 further includes determining 504 the parameters for one or more functions of the reader in the configuration. The method 500 further includes performing 506 the one or more functions of the reader to assist the base station in communicating with an ambient IoT device.

In some embodiments of the method 500, the one or more functions of the reader only comprise generating a carrier-wave for transmitting to the ambient IoT devices. In some such embodiments, the configuration comprises carrier wave parameters and backscatter wave parameters comprising: a frequency band, a transmit power, a duration of a carrier wave within a period, a periodicity, and a starting time within the period.

In some embodiments of the method 500, the one or more functions of the reader comprise: receiving a carrier-wave and R2D signals from the base station; forwarding the carrier-wave and the R2D signals to the ambient IoT device; receiving a backscatter signal from the ambient IoT device; processing the backscatter signal; and forwarding the processed backscatter signal to the base station. In some such embodiments, the configuration comprises carrier wave parameters comprising: a frequency band, a power amplification factor for forwarding to the ambient IoT device, a duration within a period, a periodicity, and a starting time within the period.

In some embodiments of the method 500, the one or more functions of the reader comprise: receiving R2D signals from the base station; forwarding the R2D signals to the ambient IoT device; generating a carrier-wave to transmit to the ambient IoT device; receiving a backscatter signal from the ambient IoT device; processing the backscatter signal; and forwarding the processed backscatter signal to the base station. In some such embodiments, the configuration comprises carrier wave parameters comprising: a frequency band, transmit power for transmitting to the ambient IoT device, a duration within a period, a periodicity, and a starting time within the period.

In some embodiments of the method 500, the parameters included in the configuration are based on which type of mode is indicated for the UE to communicate as the reader.

FIG. 6 illustrates a method 600 for a base station, according to embodiments herein. The illustrated method 600 includes generating 602 a configuration for a UE to communicate as a reader for ambient internet of things (IoT), wherein the configuration includes parameters related to functions of the UE communicating as the reader. The method 600 further includes sending 604, to a UE, the configuration for the UE-assistance mode for ambient IoT. The method 600 further includes communicating 606 with an ambient IoT device with assistance from the UE.

In some embodiments of the method 600, the configuration is for configuring the UE to generate a carrier-wave for transmitting to the ambient IoT devices. In some such embodiments, the configuration comprises carrier wave parameters and backscatter wave parameters comprising: a frequency band, a transmit power, a duration of a carrier wave within a period, a periodicity, and a starting time within the period.

In some embodiments of the method 600, the configuration is for configuring the UE to: receive a carrier-wave and R2D signals from the base station; forward the carrier-wave and the R2D signals to the ambient IoT device; receive a backscatter signal from the ambient IoT device; process the backscatter signal; and forward the processed backscatter signal to the base station. In some such embodiments, the configuration comprises carrier wave parameters comprising: a frequency band, a power amplification factor for forwarding to the ambient IoT device, a duration within a period, a periodicity, and a starting time within the period.

In some embodiments of the method 600, the configuration is for configuring the UE to: receive R2D signals from the base station; forward the R2D signals to the ambient IoT device; generate a carrier-wave to transmit to the ambient IoT device; receive a backscatter signal from the ambient IoT device; process the backscatter signal; and forward the processed backscatter signal to the base station. In some such embodiments, the configuration comprises carrier wave parameters comprising: a frequency band, transmit power for transmitting to the ambient IoT device, a duration within a period, a periodicity, and a starting time within the period.

In some embodiments of the method 600, the parameters included in the configuration are based on which type of mode is indicated in the configuration.

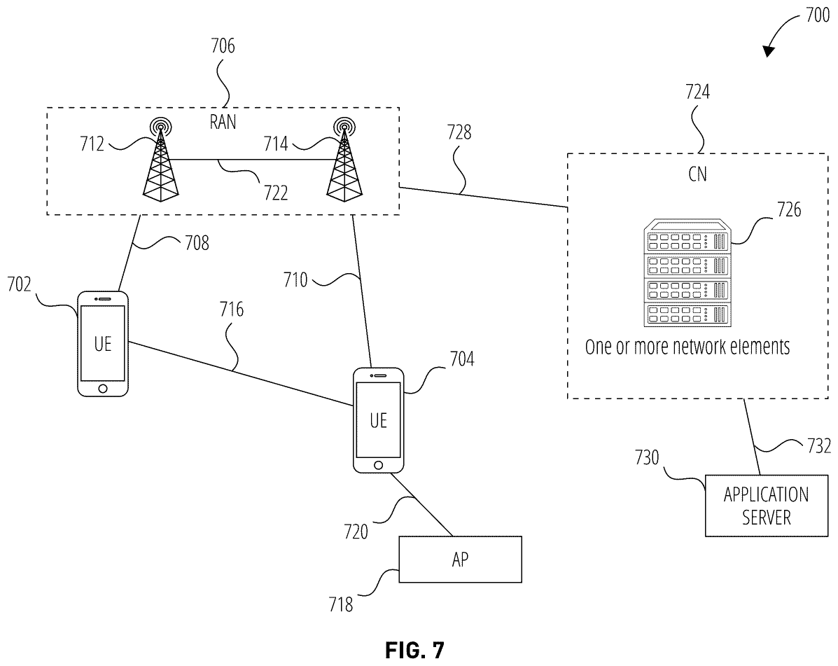

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VOIP sessions, group communication sessions, etc.) for the UE 702 and UE 704 via the CN 724. The application server 730 may communicate with the CN 724 through an IP communications interface 732.

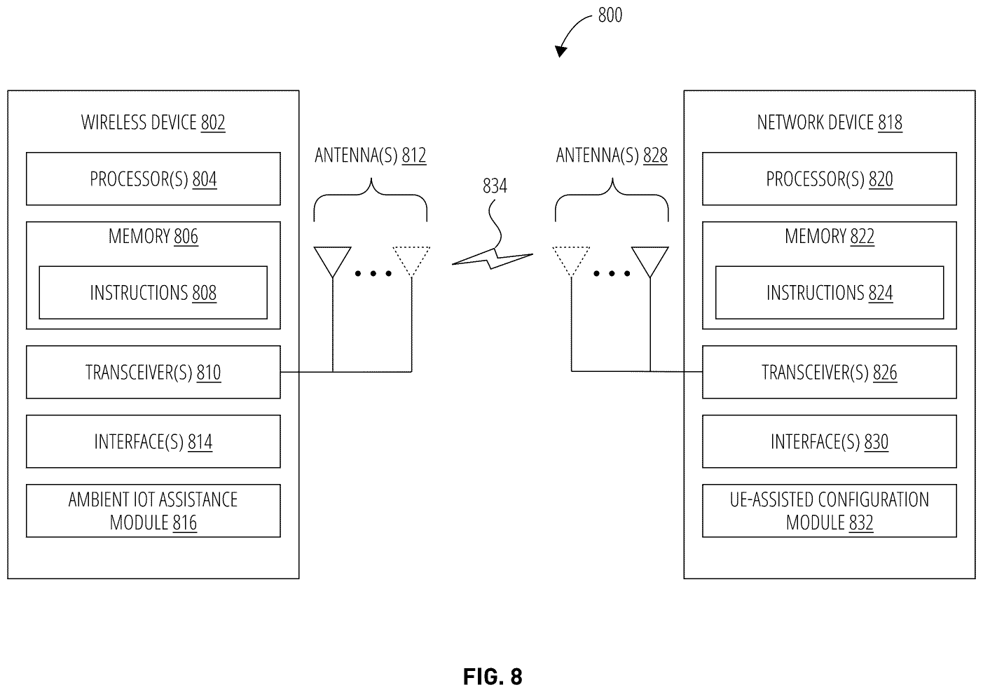

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter circuitry and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth® and the like).

The wireless device 802 may include an ambient IoT assistance module 816. The ambient IoT assistance module 816 may be implemented via hardware, software, or combinations thereof. For example, the ambient IoT assistance module 816 may be implemented as a processor, circuit, and/or instructions 808 stored in the memory 806 and executed by the processor(s) 804. In some examples, the ambient IoT assistance module 816 may be integrated within the processor(s) 804 and/or the transceiver(s) 810. For example, the ambient IoT assistance module 816 may be implemented by a combination of software components (e.g., executed by a DSP or a general processor) and hardware components (e.g., logic gates and circuitry) within the processor(s) 804 or the transceiver(s) 810.

The ambient IoT assistance module 816 may be used for various aspects of the present disclosure, for example, aspects of FIG. 1 through FIG. 7.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter circuitry and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a UE-assisted configuration module 832. The UE-assisted configuration module 832 may be implemented via hardware, software, or combinations thereof. For example, the UE-assisted configuration module 832 may be implemented as a processor, circuit, and/or instructions 824 stored in the memory 822 and executed by the processor(s) 820. In some examples, the UE-assisted configuration module 832 may be integrated within the processor(s) 820 and/or the transceiver(s) 826. For example, the UE-assisted configuration module 832 may be implemented by a combination of software components (e.g., executed by a DSP or a general processor) and hardware components (e.g., logic gates and circuitry) within the processor(s) 820 or the transceiver(s) 826.

The UE-assisted configuration module 832 may be used for various aspects of the present disclosure, for example, aspects of FIG. 1 through FIG. 7.

Embodiments contemplated herein include an apparatus comprising means to perform one or more elements of the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 802 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

Embodiments contemplated herein include an apparatus comprising means to perform one or more elements of the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 818 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
receiving, from a base station, a configuration for the UE to communicate as a reader for ambient internet of things (IoT), wherein the configuration includes parameters related to the UE communicating as the reader:
determining the parameters for one or more functions of the reader in the configuration; and
performing the one or more functions of the reader to assist the base station in communicating with an ambient IoT device.

2. The method of claim 1, wherein the one or more functions of the reader only comprise generating a carrier-wave for transmitting to the ambient IoT devices.

3. The method of claim 2, wherein the configuration comprises carrier wave parameters and backscatter wave parameters comprising: a frequency band, a transmit power, a duration of a carrier wave within a period, a periodicity, and a starting time within the period.

4. The method of claim 1, wherein the one or more functions of the reader comprise:
receiving a carrier-wave and reader-to-device (R2D) signals from the base station:
receiving a backscatter signal from the ambient IoT device; and
processing the backscatter signal.

5. The method of claim 4, further comprising forwarding the carrier-wave and the R2D signals to the ambient IoT device.

6. The method of claim 4, further comprising forwarding the processed backscatter signal to the base station.

7. The method of claim 4, wherein the configuration comprises carrier wave parameters comprising: a frequency band, a power amplification factor for forwarding to the ambient IoT device, a duration within a period, a periodicity, and a starting time within the period.

8. The method of claim 1, wherein the one or more functions of the reader comprise:
receiving reader-to-device (R2D) signals from the base station:
forwarding the R2D signals to the ambient IoT device:
generating a carrier-wave to transmit to the ambient IoT device:
receiving a backscatter signal from the ambient IoT device:
processing the backscatter signal; and
forwarding the processed backscatter signal to the base station.

9. The method of claim 8, wherein the configuration comprises carrier wave parameters comprising: a frequency band, transmit power for transmitting to the ambient IoT device, a duration within a period, a periodicity, and a starting time within the period.

10. The method of claim 1, wherein the parameters included in the configuration are based on which type of mode is indicated for the UE to communicate as the reader.

11. A method for a base station, the method comprising:
generating a configuration for a user equipment (UE) to communicate as a reader for ambient internet of things (IoT), wherein the configuration includes parameters related to functions of the UE communicating as the reader;
sending, to the UE, the configuration for the UE to communicate as a reader for ambient IoT; and
communicating with an ambient IoT device with assistance from the UE.

12. The method of claim 11, wherein the configuration is for configuring the UE to generate a carrier-wave for transmitting to the ambient IoT devices.

13. The method of claim 12, wherein the configuration comprises carrier wave parameters and backscatter wave parameters comprising: a frequency band, a transmit power, a duration of a carrier wave within a period, a periodicity, and a starting time within the period.

14. The method of claim 11, wherein the configuration is for configuring the UE to:
receive a carrier-wave and reader-to-device (R2D) signals from the base station;
forward the carrier-wave and the R2D signals to the ambient IoT device:
receive a backscatter signal from the ambient IoT device:
process the backscatter signal; and
forward the processed backscatter signal to the base station.

15. The method of claim 14, wherein the configuration comprises carrier wave parameters comprising: a frequency band, a power amplification factor for forwarding to the ambient IoT device, a duration within a period, a periodicity, and a starting time within the period.

16. The method of claim 11, wherein the configuration is for configuring the UE to:
receive reader-to-device (R2D) signals from the base station:
forward the R2D signals to the ambient IoT device:
generate a carrier-wave to transmit to the ambient IoT device:
receive a backscatter signal from the ambient IoT device:
process the backscatter signal; and
forward the processed backscatter signal to the base station.

17. The method of claim 16, wherein the configuration comprises carrier wave parameters comprising: a frequency band, transmit power for transmitting to the ambient IoT device, a duration within a period, a periodicity, and a starting time within the period.

18. The method of claim 11, wherein the parameters included in the configuration are based on which type of mode is indicated in the configuration.

19. A user equipment (UE) apparatus comprising:
a processor; and
a memory storing instructions that, when executed by the processor, configure the apparatus to:
receive, from a base station, a configuration for the UE to communicate as a reader for ambient internet of things (IoT), wherein the configuration includes parameters related to the UE communicating as the reader:
determine the parameters for one or more functions of the reader in the configuration; and
perform the one or more functions of the reader to assist the base station in communicating with an ambient IoT device.

20. The thing of claim 19, wherein the one or more functions of the reader only comprise generating a carrier-wave for transmitting to the ambient IoT devices.
